(19) United States
(12) Patent Application Publication
(10) Pub. No.: US 2026/0280990 A1
(43) Pub. Date: Sep. 17, 2026

(54) QUICK CUTSHEET FOR TERMINATION AND ORGANIZATION OF CABLES IN NETWORK INFRASTRUCTURE ROOMS

(71) Applicant: Allan Battle II, Howell, NJ (US)

(72) Inventor: Allan Battle II, Howell, NJ (US)

(73) Assignee: Allan Battle, II, Howell, NJ (US)

(21) Appl. No.: 19/080,871

(22) Filed: Mar. 16, 2025

(51) Int. Cl. H04L 41/12; H04L 41/0853

(52) U.S. Cl. CPC H04L 41/12; H04L 41/0856

(57) ABSTRACT

The present invention relates to a quick cutsheet for the termination and organization of cables in network infrastructure rooms. The quick cutsheet may streamline the termination and organization of cables in network infrastructure rooms, such as IDF rooms, MDF rooms, data closets, AV racks, and IT rooms. The quick cutsheet may provide a comprehensive overview of the cabling layout, including patch panel numbers, patch panel ports, left and right-side termination designations, and a detailed “key” that specifies the status of each cable (missing, found, tested, doubled/duplicated).

### CROSS-REFERENCE TO RELATED APPLICATIONS

This application claims the benefit of U.S. Provisional Patent Application No. 63/642,197, filed on May 3, 2024, entitled “QUICK CUTSHEET FOR TERMINATION AND ORGANIZATION OF CABLES IN NETWORK INFRASTRUCTURE ROOMS,” the entire contents of which are incorporated herein by reference.

### FIELD OF THE DISCLOSURE

This invention generally relates to the management of network infrastructure and is more particularly related to quick cutsheet for termination and organization of cables in network infrastructure rooms.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the present disclosure.

Network infrastructure rooms, such as Intermediate Distribution Frame (IDF) rooms, Main Distribution Frame (MDF) rooms, data closets, AV racks, and IT rooms, are critical components of modern telecommunications and networking systems. These rooms serve as central hubs for connecting and distributing low-voltage cabling that carries data, voice, and video signals throughout an organization's infrastructure. Proper organization and termination of low-voltage cabling in these rooms are essential for ensuring the reliability, scalability, performance, and proper location of cabling of the network.

Traditional methods of managing low-voltage cabling in network infrastructure rooms often involve manual documentation and labeling. Network administrators typically use spreadsheets or other documentation tools to keep track of which cables are connected to which ports on patch panels, as well as the status of each cable (e.g., missing, found, tested, doubled/duplicated). However, these manual methods are labor-intensive, prone to errors, and can be difficult to maintain, especially in large-scale network environments. One common practice for the management of network infrastructure rooms is using scrap cardboard or other makeshift materials to create on-the-spot cutsheets for organizing and tracking low-voltage cabling. These makeshift cutsheets are often created manually and can be time-consuming, taking anywhere from 20 minutes to over an hour to create just one cutsheet. The use of scrap cardboard cutsheets is a result of the lack of efficient tools and methods for managing low-voltage cabling in network infrastructure rooms. Network administrators resort to these makeshift solutions due to the absence of automated and systematic approaches for organizing and tracking cabling.

However, relying on scrap cardboard cutsheets is inefficient and prone to errors. These cutsheets are often difficult to maintain and update, leading to confusion and inefficiencies in managing the network infrastructure. Additionally, the time wasted in creating these cutsheets manually could be better spent on other critical tasks related to network maintenance and optimization.

There is a growing need for a cleaner, errorfree, more automated and systematic approaches to managing low-voltage cabling in network infrastructure rooms. These approaches should streamline the organization and tracking of cabling, reduce the time and effort required for documentation, and improve overall efficiency in managing network infrastructure.

### SUMMARY

The present invention discloses a quick cutsheet for the termination and organization of cables in network infrastructure rooms according to an embodiment of the present invention. In an embodiment, the present invention relates to a cutsheet designed for the efficient organization and termination of cables in network infrastructure rooms. In one embodiment, the cutsheet is constructed from a substrate that may be made of paper, corrugated plastic, or a combination of both materials. The selection of the substrate can vary based on durability requirements, with corrugated plastic providing enhanced water resistance, reusability, and longevity, while paper-based versions may feature a laminated or coated surface to improve durability and wear resistance.

In an embodiment, the cutsheet includes a printed layout designed to facilitate rapid identification and organization of cable terminations. The layout comprises patch panel identifiers arranged in a tabular format, each corresponding to a patch panel within the network infrastructure. Cable status indicators are also incorporated into the layout to denote the termination state of each cable, including at least missing, found, tested, and duplicated cables. In some variations, additional status indicators such as pulled, confirmed, and terminated may be included to provide more comprehensive tracking of cable installations.

In yet another embodiment, the cutsheet features dedicated left-side and right-side termination sections, ensuring that network administrators can clearly distinguish between the terminations on each side of the patch panel. These sections may be customizable based on user preferences or network configurations, allowing adaptability for different patch panel layouts. Additionally, the cutsheet includes a job-specific information section designed to capture essential details such as installation location, floor number, and rack designation, making it easier to reference specific network setups.

In some embodiments, the printed layout is generated using high-quality digital printing, UV printing, or screen-printing techniques to ensure enhanced readability and long-term usability. The layout may also incorporate grid lines and bold markers to further improve visibility and facilitate accurate documentation of cable statuses. To enhance usability in network infrastructure rooms, the cutsheet can be mounted on various surfaces using magnetic strips, adhesive backing, or hook-and-loop fasteners, ensuring a secure and accessible placement for technicians and administrators. The cutsheet is designed for compatibility with a range of patch panel systems, including 24-port, 48-port, and combination configurations, making it suitable for diverse network environments. By offering a structured and standardized approach to cable organization, the invention eliminates inefficiencies associated with manual tracking methods, such as using scrap cardboard sheets or handwritten documentation. The standardized format enhances clarity, reduces errors, and improves overall efficiency in network management, providing a valuable tool for network administrators and IT professionals.

The present invention addresses the shortcomings of traditional methods by providing a comprehensive system and method for managing low-voltage cabling in network infrastructure rooms. The system includes a spreadsheet-based tool that allows network administrators to easily organize and track the status of low-voltage cabling in patch panels. The spreadsheet tool provides detailed information about each patch panel, including patch panel numbers, patch panel ports, left and right-side termination designations, and a “key” that indicates the status of each cable (e.g., missing, found, tested, doubled/duplicated). This information helps current and new network administrators to a certain project quickly be able to pick-up and confidently identify and resolve issues with the cabling, such as identifying missing or doubled/duplicated cables, and ensures that the cabling is properly organized and terminated. Overall, the quick cutsheets for managing low voltage cabling in network infrastructure rooms provide a valuable tool for network administrators to maintain a reliable, scalable, and efficient network infrastructure.

The Features and advantages of the subject matter here will become more apparent in light of the following detailed description of selected embodiments, as illustrated in the accompanying Figures. As will be realized, the subject matter disclosed is capable of modifications in various aspects, all without departing from the scope of the subject matter. Accordingly, the drawings and the description are to be regarded as illustrative in nature.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a quick cutsheet for the termination and organization of cables in network infrastructure rooms, in accordance with an embodiment of the present invention.

FIG. 2 illustrates a left side of the quick cutsheet for the termination and organization of cables in network infrastructure rooms, in accordance with an embodiment of the present invention.

FIG. 3 illustrates a right side of the quick cutsheet for the termination and organization of cables in network infrastructure rooms, in accordance with an embodiment of the present invention.

FIG. 4 illustrates a side view of the quick cutsheet printed direct to backing board, in accordance with an embodiment of the present invention.

Other features of embodiments of the present invention will be apparent from the accompanying drawings and detailed description that follows.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which numerals represent like elements throughout the several figures, and in which example embodiments are shown. Embodiments of the present disclosure may, however, be embodied in many different forms and should not be construed as limited to the embodiments set forth herein. The examples set forth herein are non-limiting examples and are merely examples among other possible examples.

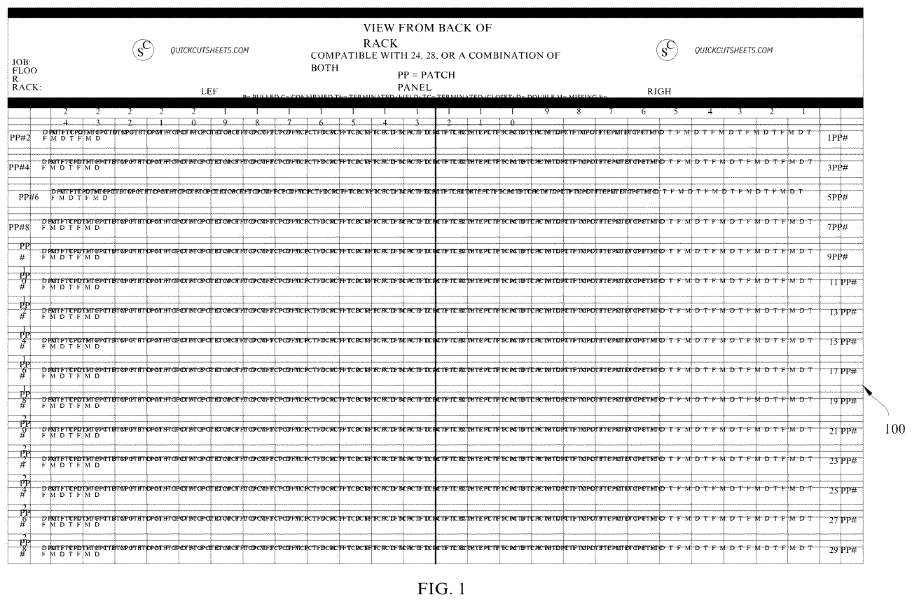

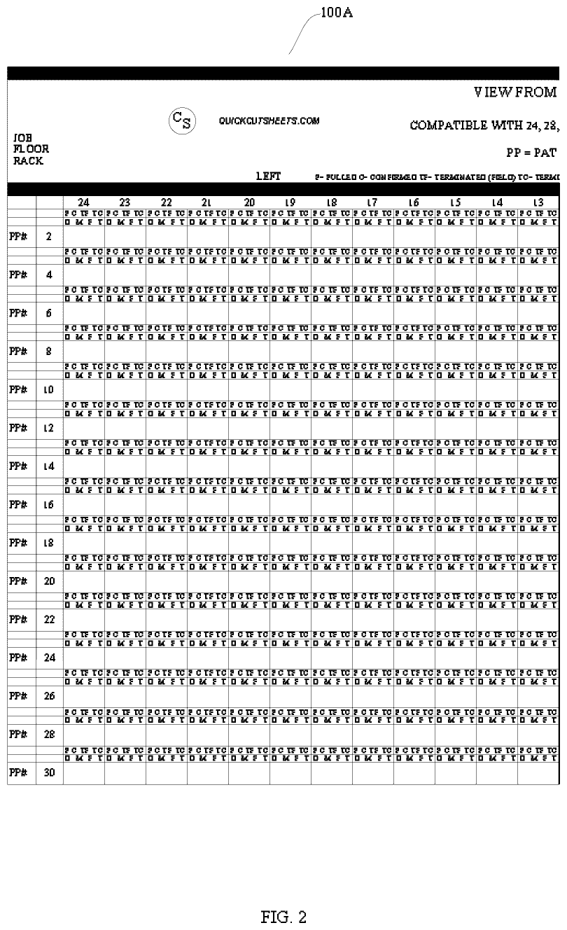

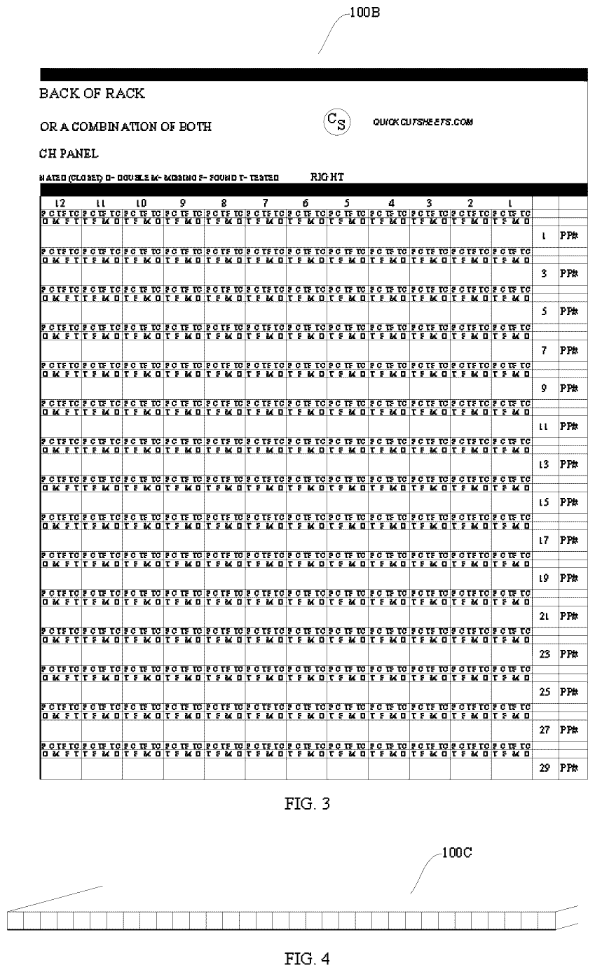

FIG. 1 illustrates a quick cutsheet 100 for the termination and organization of cables in network infrastructure rooms, in accordance with an embodiment of the present invention. FIG. 2 illustrates a left side 100A of the quick cutsheet 100 for the termination and organization of cables in network infrastructure rooms, in accordance with an embodiment of the present invention. FIG. 3 illustrates a right side 100B of the quick cutsheet 100 for the termination and organization of cables in network infrastructure rooms, in accordance with an embodiment of the present invention. FIG. 4 illustrates a side view 100C of the quick cutsheet 100 printed direct to backing board, in accordance with an embodiment of the present invention. For the sake of brevity, FIGS. 1, 2, 3, and 4 have been explained together.

In an embodiment, the quick cutsheet 100 may be a solution aimed at streamlining the termination and organization of cables in network infrastructure rooms, such as Intermediate Distribution Frame (IDF) rooms, Main Distribution Frame (MDF) rooms, data closets, audiovisual racks, and IT rooms. The quick cutsheet 100 may provide a comprehensive overview of the cabling layout, including patch panel numbers, patch panel ports, left and right-side termination designations, and a detailed “key” that specifies the status of each cable i.e., missing, found, tested, doubled/duplicated.

In an embodiment, as illustrated in FIG. 1, the quick cutsheet 100 comprises a substrate made from a material selected from paper, corrugated plastic, or a combination thereof. In one embodiment, the substrate is made from corrugated plastic, which provides enhanced durability, water resistance, and reusability, making it suitable for long-term use in network infrastructure environments. In another embodiment, the substrate may be made of paper with a laminated or coated surface to improve durability while maintaining cost efficiency.

In an embodiment, the printed layout on the cutsheet 100 is designed for clear and organized documentation of cable terminations. The layout includes multiple structural components, as shown in FIG. 2 and FIG. 3, including a left-side termination section 100A and a right-side termination section 100B, each defining cable terminations for a respective side of the patch panels. The layout also includes a plurality of patch panel identifiers arranged in a tabular format, where each patch panel identifier corresponds to a specific patch panel within the network infrastructure room. The cable status indicators allow users to identify the state of cables quickly. Each cable status indicator represents a specific termination status, including at least missing, found, tested, and duplicated. In some embodiments, the indicators may also include additional states such as pulled, confirmed, and terminated to provide more comprehensive tracking of cable installations.

In an embodiment, the quick cutsheet 100 includes fillable fields for recording job-specific information. As illustrated in FIG. 1, the job-specific information section allows users to enter details about the installation location, floor number, and rack designation. This section ensures that administrators can track and reference cutsheets efficiently for different network configurations. The printed layout is highly visible and easy to read, making it user-friendly. In one embodiment, the layout is created using digital printing, UV printing, or screen-printing techniques to enhance readability and durability. The printed layout may also feature grid lines and bold markers to facilitate quick interpretation by network technicians.

To improve ease of use, the quick cutsheet 100 can be mounted in various ways. In an embodiment, as shown in FIG. 4, the cutsheet 100 may be secured using magnetic strips, adhesive backing, or hook-and-loop fasteners, ensuring that the cutsheet remains in place in network rooms without interfering with the workspace. The quick cutsheet 100 is compatible with various patch panel configurations, including 24-port, 48-port, or combination patch panel systems. This flexibility ensures that different network infrastructure setups can efficiently utilize the quick cutsheet 100 without requiring redesigns.

As illustrated in FIG. 4, the quick cutsheet 100 can also be mounted on a backing board for additional structural rigidity, preventing bending or tearing during use. This feature enhances the cutsheet's durability and usability in high-traffic network environments. Unlike traditional handwritten or scrap cardboard cutsheets, which are prone to errors and inefficiencies, the quick cutsheet 100 provides a pre-printed, standardized solution that significantly reduces the time required for documentation. Network administrators no longer need to spend 20 minutes to over an hour creating a single cutsheet manually. Instead, they can simply reference the pre-prepared quick cutsheet 100, allowing for immediate use and efficiency. The structured printed layout, combined with the patch panel identifiers and cable status indicators, minimizes the risk of misinterpretation and errors, improving network infrastructure reliability. This leads to a more efficient and organized cable termination process, reducing downtime and confusion in network maintenance and troubleshooting.

In conclusion, the quick cutsheet 100 represents a significant improvement in network cable management. By incorporating a durable substrate, an optimized printed layout, structured cable tracking indicators, and multiple mounting options, the quick cutsheet 100 is a comprehensive, time-saving, and efficient tool for network administrators. The present invention eliminates manual errors, improves network reliability, and optimizes the efficiency of cable organization in data centers, IT rooms, and telecommunications infrastructure. The flexibility of the cutsheet 100 in terms of material, customization, and layout configurations makes it a versatile solution adaptable to different network setups.

In an embodiment, as illustrated in FIG. 1, the quick cutsheet 100 may include fillable options against entries such as “job” and “floor” to indicate the job type and floor type respectively in an organization. Further, the quick cutsheet may be divided into two sides, namely a “left side” (as shown in FIG. 2) and a “right side” (as shown in FIG. 3). Furthermore, the rows on the quick cutsheet 100 may be indicative of patch panel numbers, ranging for example from 1-30 or 1-60, and the columns may be indicative of cables ranging from 1-24 with 1-12 on the “right side” and 13-24 on the “left side”. Thus, each entry made in the quick cutsheet 100 may be an entry in a matrix, for example, 15×24 or 30×24. It may be apparent to a person skilled in the art that the number of patch panels, cables, matrix, or the like may vary and may be customized as per the need of the user without departing from the scope of the invention. Further, each entry pertaining to a cable may be marked by only the symbols “D,” “M,” “F,” and “T” representing “Double/Duplicate,” “Missing,” “Found,” and “Tested”. In an embodiment, such quick cutsheets may be made on any material such as backing board (as shown in FIG. 4), cardboard, or the like.

Unlike traditional methods that rely on scrap cardboard or other makeshift materials, the quick cutsheet 100 is a ready-made, cleaner, and neater solution that significantly reduces the time and effort required for documentation. Network administrators no longer need to spend 20 minutes to over an hour creating a single cutsheet. Instead, they can quickly reference the pre-prepared cutsheet, saving valuable time and resources. One of the key advantages of the quick cutsheet 100 is its clarity and ease of use. Wet or dry erase markers can be used for highest visibility and allowing for any errors to be erased ensuring a clean-cut sheet. The information is presented in a structured and organized format, making it easy for network administrators to quickly identify the status of each cable and take appropriate action. This reduces the risk of errors and confusion that can arise from using improper or outdated cutsheets.

Furthermore, the quick cutsheet 100 eliminates wasted man-hours and confusion associated with using improper cutsheets. Network administrators can confidently rely on the quick cutsheet to ensure that the cabling is properly terminated and organized, leading to more efficient and reliable network infrastructure. In conclusion, the quick cutsheet 100 is a game-changing innovation that revolutionizes the way low voltage cabling is managed in network infrastructure rooms. Its efficiency, clarity, and ease of use make it an indispensable tool for network administrators seeking to optimize the organization and termination of cables in their network infrastructure.

It has thus been seen that the quick cutsheet 100 for termination and organization of cables in network infrastructure rooms according to the present invention achieves the purposes highlighted earlier. The quick cutsheet 100 for termination and organization of cables in network infrastructure rooms can, in any case, undergo numerous modifications and variants, all of which are covered by the same innovative concept; moreover, all the details can be replaced by technically equivalent elements. In practice, the materials used, as well as the shapes and sizes, can be whatever according to the technical requirements.

The quick cutsheet 100 may undergo modifications and enhancements, such as customized color schemes, additional tracking indicators, or integration with digital systems, without departing from the scope of the invention. The materials, shapes, and dimensions of the cutsheet 100 may be adjusted based on technical requirements while maintaining the core functionality of organized cable management.

While the foregoing describes various embodiments of the disclosure, other and further embodiments of the disclosure may be devised without departing from the basic scope thereof. The disclosure is not limited to the described embodiments, versions, or examples, which are included to enable a person having ordinary skill in the art to make and use the disclosure when combined with information and knowledge available to the person having ordinary skill in the art.

What is claimed is:

1. A cutsheet for organizing and terminating cables in a network infrastructure room, the cutsheet comprising:
a substrate made of a material selected from paper, corrugated plastic, or a combination thereof;
a printed layout on the substrate, the printed layout including:
a plurality of patch panel identifiers arranged in a tabular format, each patch panel identifier corresponding to a patch panel in the network infrastructure room;
a plurality of cable status indicators, each cable status indicator denoting a termination state of a cable, wherein the termination states include at least missing, found, tested, and duplicated;
a left-side and right-side termination section, each section defining cable terminations for a respective side of the patch panel; and
a job-specific information section configured to receive user-inputted details about installation location, floor number, and rack designation;
wherein the cutsheet is designed for visual organization and rapid identification of cable statuses in the network infrastructure room.

2. The cutsheet of claim 1, wherein the substrate comprises corrugated plastic to provide enhanced durability, water resistance, and reusability.

3. The cutsheet of claim 1, wherein the substrate comprises paper with a laminated or coated surface to improve durability.

4. The cutsheet of claim 1, wherein the cable status indicators further include at least one of pulled, confirmed, and terminated to improve clarity for current and future users new to the projects.

5. The cutsheet of claim 1, wherein the printed layout is generated using a digital printing process, UV printing, or screen printing for enhanced readability by allowing for usage of at least one of: wet and dry erase markers to remove any unwanted numbers and markings.

6. The cutsheet of claim 1, wherein the printed layout includes a pre-defined key or legend explaining the meaning of the cable status indicators.

7. The cutsheet of claim 1, wherein the cutsheet is designed to be mounted on a surface using magnetic strips, adhesive backing, or hook-and-loop fasteners.

8. The cutsheet of claim 1, wherein the left-side and right-side termination sections are customizable based on user preferences or network configuration.

9. The cutsheet of claim 1, wherein the cutsheet is configured for use in 24-port, 48-port, or combination patch panel systems.

10. The cutsheet of claim 1, wherein the printed layout includes grid lines and bold markers to facilitate easy reading and interpretation.
